(19) United States
(12) Patent Application Publication
(10) Pub. No.: US 2013/0002607 A1
(43) Pub. Date: Jan. 3, 2013

(54) SINGLE-AXIS CAPACITIVE MULTI-TOUCH PANEL, SYSTEM AND METHOD

(76) Inventor: Gokalp Bayramoglu, Xiamen (CN)

(21) Appl. No.: 13/634,240

(22) PCT Filed: Nov. 11, 2010
(86) PCT No.: PCT/CN2010/001807

§ 371 Date: Sep. 12, 2012

(51) Int. Cl. G06F 3/041

(52) U.S. Cl. 345/174

(57) ABSTRACT

The present invention is directed to a single-axis capacitive multi-touch panel, system and method. A multi-touch panel includes a substrate and some conductive lines formed on one side of the substrate, wherein the conductive lines are arranged in a single axis. A driving circuit, for producing an alternating-current signal, is operatively coupled to the conductive lines of the multi-touch panel, and measuring circuit, for receiving an output signal according to the alternating-current signal to determine touch location, i s operatively coupled to the conductive lines of the multi -touch panel.

### BACKGROUND OF THE INVENTION

1. Field of the Invention

The present invention generally relates to a touch panel, and more particularly to a single-axis capacitive multi-touch panel, system and method.

2. Description of Related Art

Touchscreen displays have been widely used in electronic devices such as portable and hand-held electronic devices. Touchscreen displays incorporate sensing technology and display technology. Growing liquid crystal display (LCD) developments further facilitate the integration of the sensing technology with the LCD.

Capacitive touch panel is one common type of the touch panel technologies. The capacitive touch panel utilizes capacitive sensing technology based on capacitive coupling effects for detecting touching position. A change in capacitance may be detected when a finger touches the surface of the capacitive touch panel. The detection may be based on self capacitance or mutual capacitance. In both self capacitance and mutual capacitance systems, electrodes of the multi-touch panel are manufactured in two axes to determine the touch location.

The self-capacitance touch panel performs based on the capacitance between electrodes and GND. As to the two-axis touch panel, there are lateral electrodes and longitudinal electrodes made of conductive materials, such as Indium Tin Oxide (ITO). The detection is based on the self-capacitance between lateral electrodes and GND, and the self-capacitance between longitudinal electrodes and GND. The self-capacitance changes relating to the lateral electrodes and the longitudinal electrodes are detected before and after touching to determine the touching point.

The mutual-capacitance touch panel performs based on the capacitance between different axis electrodes, such as between the lateral electrodes and the longitudinal electrodes in the coordinate system of two axes. Touching, for example, by a finger will affect the capacitive coupling at the touching point, and thus change its 20. mutual-capacitance. In determining the touching point, the lateral electrodes are driven with signals and responses at the longitudinal electrodes are sensed.

FIG. 1A shows a schematic top view of a conventional touch panel, and FIG. 1B shows a cross-sectional view taken along a sectional line 1B-1B′ of FIG. 1A. Specifically, the lateral electrodes 12 are formed on the top surface of a substrate 10, and the longitudinal electrodes 14 are formed on the bottom surface of the substrate 10.

FIG. 1C shows a schematic top view of another conventional touch panel, and FIG. 1D shows a cross-sectional view taken along a sectional line 1D-1D′ of FIG. 1C. Specifically, the lateral electrodes 12 are formed on one side (e.g., the top surface) of the substrate 10, and the longitudinal electrodes 14 are formed over the lateral electrodes 12 and on the same side (i.e., the top surface) of the substrate 10. Discrete insulating areas 13 are additionally formed at crossover points between the lateral electrodes 12 and the longitudinal electrodes 14 to respectively provide insulation so that the lateral electrodes 12 and the longitudinal electrodes 14 will not create a short circuit.

It is noted that, in both the self-capacitance and the mutual-capacitance touch panels, electrodes are manufactured in two axes, such as Cartesian coordinate system or polar coordinate system, to determine the touching location. However, using two axes complicates their manufacturing process. Regarding the touch panel as shown in FIG. 1A, for example, two ITO layers need to be formed to manufacture the lateral electrodes 12 and the longitudinal electrodes 14 respectively. Regarding the touch panel as shown in FIG. 1C, an additional insulating layer need to be formed to manufacture the crossover-point insulating areas 13 so that conductive lines on each axis will not create a short circuit.

Conventional touch panels are designed to report a single touching location even when multiple objects are present on the surface of the touch panel at the same time. Oftentimes, an average of all simultaneously touching points is determined at best and a single point that falls somewhere among the touching points is reported. In order to expand the applicability of the touch panel, a multi-touch panel thus becomes a growing trend that provides the function of simultaneously recognizing or reporting two or more touching points.

For the reason that conventional touch panels either suffer complex manufacturing process or could not simultaneously register multiple touching points, a need has arisen to propose a novel multi-touch panel that has a simple structure and requires simplified manufacturing process.

### SUMMARY OF THE INVENTION

In view of the foregoing, embodiments of the present invention provide a single-axis capacitive multi-touch panel, system and method, which use single layer and single axis electrodes, thereby simplifying the process of manufacturing the multi-touch panel. The multiple touches on the same conductive line can be detected.

According to one embodiment, the multi-touch panel includes a substrate and a number of conductive lines formed on one side of the substrate, wherein the conductive lines are arranged in a single axis. Each conductive line is operatively coupled to receive an alternating-current signal, and an output signal according to the alternating-current signal is then measured to determine touch location.

According to another embodiment, the single-axis capacitive multi-touch system includes a multi-touch panel, a driving circuit and a measuring circuit. The multi-touch panel includes a substrate and a number of conductive lines formed on one side of the substrate, wherein the conductive lines are arranged in a single axis. The driving circuit, for producing an alternating-current signal, is operatively coupled to the conductive lines of the multi-touch panel. The measuring circuit, for receiving an output signal according to the alternating-current signal to determine touch location, is operatively coupled to the conductive lines of the multi-touch panel.

According to a further embodiment, the single-axis capacitive multi-touch method performs as follows. An alternating-current signal with a respective frequency is provided, followed by driving a number of conductive lines in turn by the alternating-current signal to generate an electromagnetic field. An output signal is received from the conductive lines. Characteristics of a transfer function of the conductive line are determined based on the alternating-current signal and the output signal, thereby determining touching points on the conductive line.

### BRIEF DESCRIPTION OF THE DRAWINGS

Many aspects of the present structure and manufacture method can be better understood with reference to the following drawings. The components in the drawings are not necessarily to scale, emphasis instead being placed upon clearly illustrating the principles of the present disclosures. Moreover, in the drawings, like reference numerals designate corresponding parts throughout the several views.

FIG. 1A shows a schematic top view of a conventional touch panel;

FIG. 1B shows a cross-sectional view taken along a sectional line 1B-1B′ of FIG. 1A;

FIG. 1C shows a schematic top view of another conventional touch panel;

FIG. 1D shows a cross-sectional view taken along a sectional line 1D-1D′ of FIG. 1C;

FIG. 2A shows a schematic diagram that illustrates a single-axis capacitive multi-touch system according to one embodiment of the present invention;

FIG. 2B shows a cross-sectional view taken along a sectional line 2B-2B′ of FIG. 2A;

FIG. 2C shows a cross-sectional view of a touchscreen display;

FIG. 2D to FIG. 2F show some exemplary conductive lines formed on the substrate;

FIG. 3 shows an electrical equivalent circuit of one of the conductive lines in FIG. 2A/2B;

FIG. 4A shows an electrical equivalent circuit of one conductive line after two nodes are touched;

FIG. 4B shows an electrical equivalent circuit of one conductive line after three nodes are touched;

FIG. 5 shows a flow diagram that illustrates a method of operating a single-axis capacitive multi-touch system according to one embodiment of the present invention; and

FIG. 6 shows an exemplary embodiment of the multi-touch system of FIG. 2A/B.

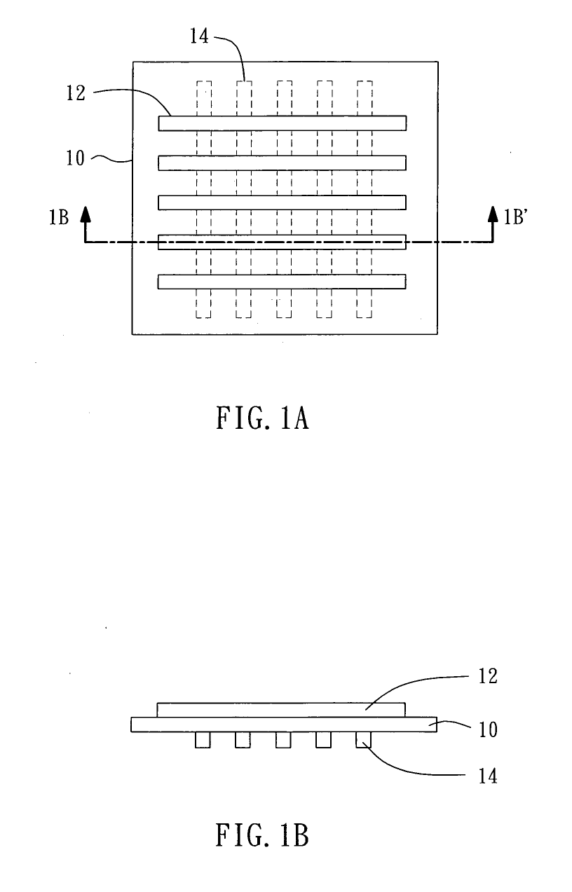

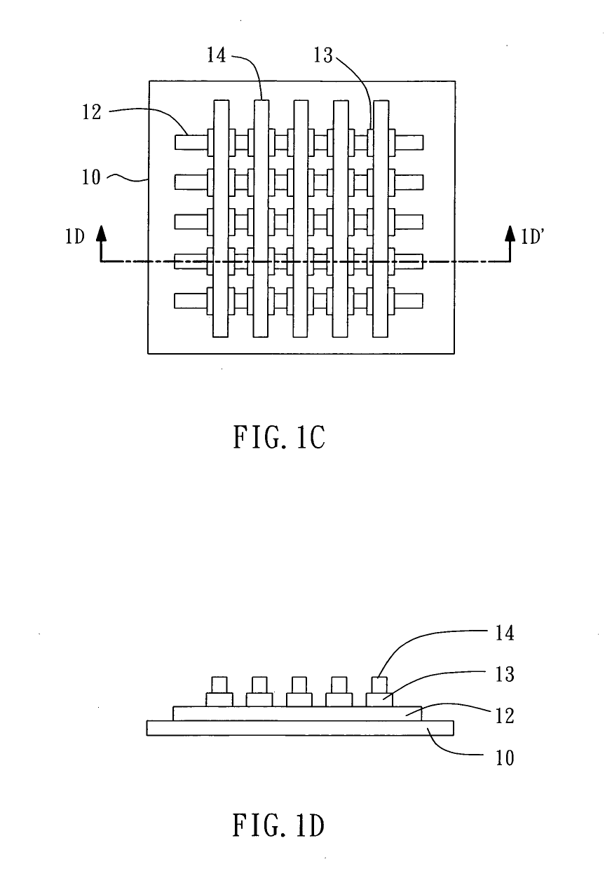

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

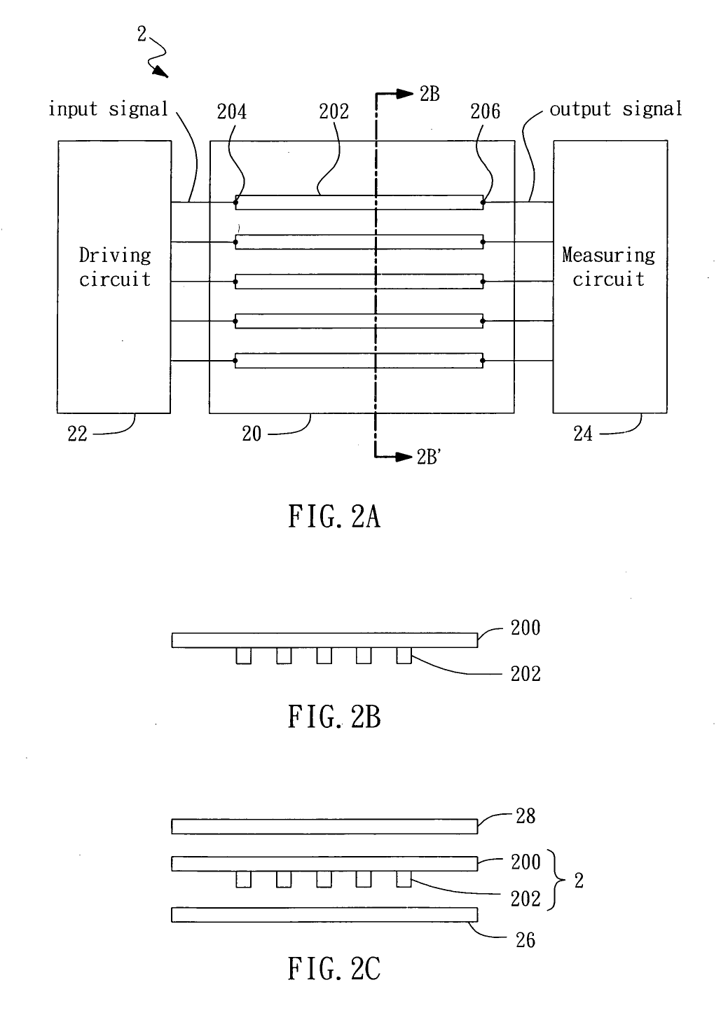

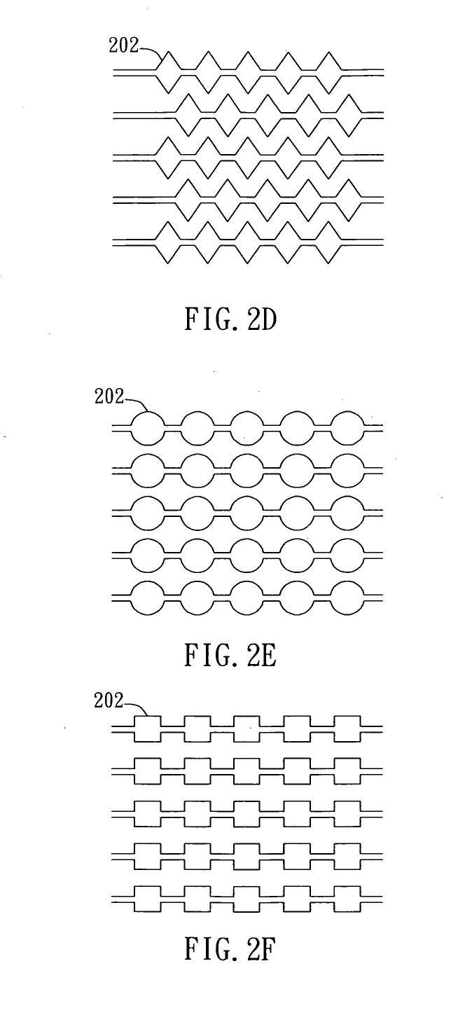

FIG. 2A shows a schematic diagram that illustrates a single-axis capacitive multi-touch system 2 according to one embodiment of the present invention. FIG. 2B shows a cross-sectional view taken along a sectional line 2B-2B′ of FIG. 2A. The single-axis capacitive multi-touch system (the multi-touch system for short) 2 is capable of simultaneously recognizing or reporting two or more touching points. As shown in FIG. 2C, the multi-touch system 2 may be integrated with a display 26 such as a liquid crystal display (LCD) to result in a touchscreen display, for example, by disposing the multi-touch system 2 in front of the LCD. A cover 28 made of, e.g., glass or acrylic, may be disposed over the multi-touch system 2 to act as a touching surface. The cover 28, the multi-touch system 2 and the display 26 may be bonded together, for example, by using transparent adhesive. The resultant touchscreen display may be further integrated with a host device such as a computer.

In the embodiment, the multi-touch system 2 includes a single-axis capacitive multi-touch panel (the multi-touch panel for short) 20, a driving circuit 22 operatively coupled to the input nodes 204 of the multi-touch panel 20, and a measuring circuit 24 operatively coupled to the output nodes 206 of the multi-touch panel 20. Specifically, the multi-touch panel 20 primarily includes a substrate 200 and a number of elongated conductive lines (or electrodes) 202 formed on one side (e.g., the bottom side or the top side) of the substrate 200. The substrate 200 may be, but not limited to, a transparent substrate. For the purpose of illustration, only five conductive lines are shown while the number of the conductive lines may be specifically designed according to specific requirements and applications. The substrate 200 may be made of, but not limited to, glass, plastic and/or the like. The conductive lines 202 may be made of transparent conductive material such as Indium tin oxide (ITO) or Antimony tin oxide (ATO), which is electrically conductive and optically transparent. The conductive lines 202 are arranged in a single axis. In the embodiment, the conductive lines 202 are spatially separated from each other without crossing, and are preferably parallel to each other. Although straight lines are shown, it is appreciated by those skilled in the art that the shape (e.g., the width) of each conductive line 202 may be varied along the conductive line 202 in order to change its electrical property such as resistance or inductance. FIG. 2D to FIG. 2F show some exemplary conductive lines 202 formed on the substrate 200. As shown, the conductive lines 202 might be of different shapes, such as diamond-shaped, rounded or square.

The single-side pattern of the conductive lines 202 may be manufactured by firstly vacuum sputtering a conductive layer, for example, on the bottom surface of the substrate 200. Subsequently, a photoresist layer is applied to the conductive layer, and the photoresist layer is then covered with a patterned photomask, followed by exposing to ultraviolet (UV) and developing the photoresist layer, thereby exposing regions of the conductive layer. After etching the exposed regions, the conductive lines or electrodes 202 are thus formed in the conductive layer, followed by removing the remaining photoresist on the conductive layer.

The driving circuit 22 and the measuring circuit 24 may be formed on the peripheral edge of the substrate 200. Alternatively, the driving circuit 22 and the measuring circuit 24 may be operatively coupled to the substrate 200, for example, via flexible printed circuit board.

The driving circuit 22 provides input signals for conductive lines 202 of the multi-touch panel 20. The input signal is an alternating-current signal. Any conductive line 202 has an inherent resistance to a current flowing through it. It generates electromagnetic field when an alternating current flows through it. This electromagnetic field generation produces inductance where the inductive reactance of the conductive line changes with a changing frequency of the alternating-current signal. If a capacitance is introduced at any point of the conductive line, then the combination of the inductance, resistance and the capacitance will form a filter.

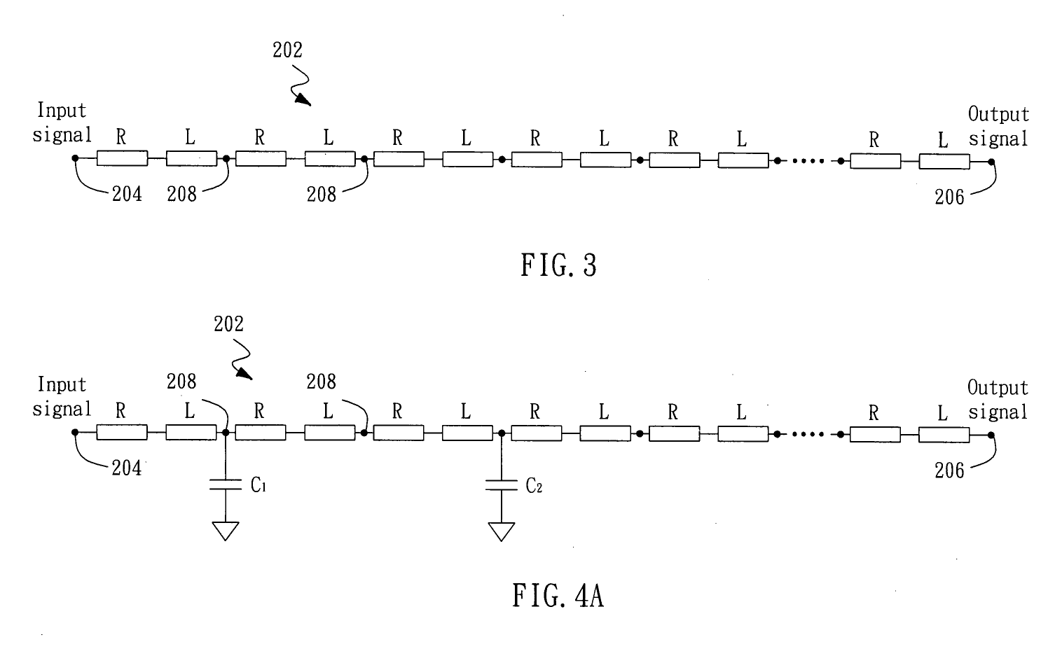

FIG. 3 shows an electrical equivalent circuit of one of the conductive lines 202 in FIG. 2A/2B. As shown in the figure, the conductive line 202 may be modeled as an RL interconnected line having a number of segments. Each segment includes a resistor R and an inductor L in series between two neighboring nodes 208, between input node 204 and its neighboring node 208, or between the output node 206 and its neighboring node 208. In the embodiment, the number of segments of the conductive line 202 corresponds to the number of touching points (e.g., nodes 208).

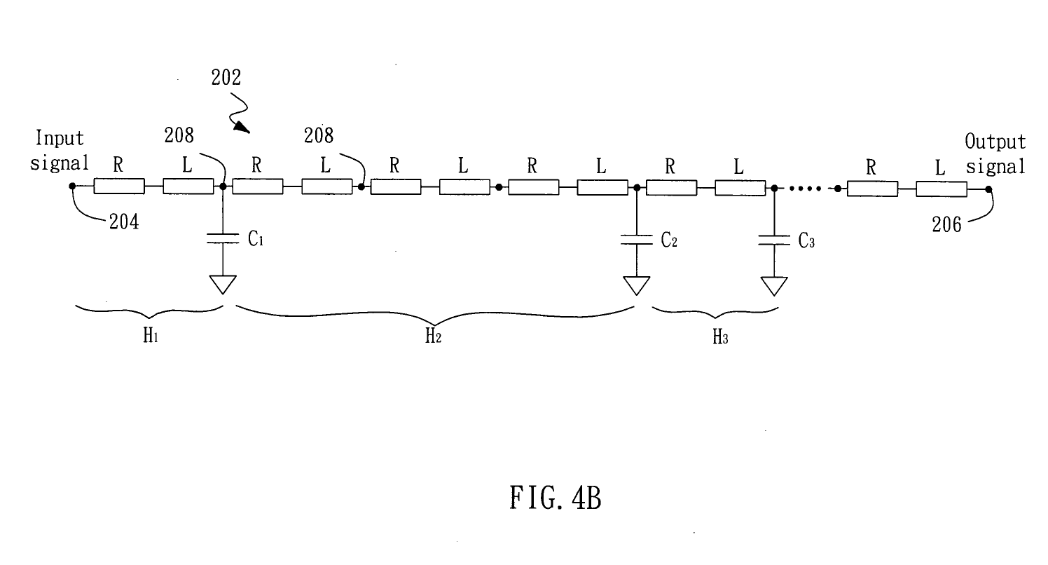

FIG. 4A shows an electrical equivalent circuit of one conductive line 202 after two nodes 208 are touched, for example, by fingers. Capacitance C₁ and capacitance C₂ are respectively introduced due to the interaction between the fingers and the electromagnetic field along the conductive line 202 that is activated. The capacitance C₁ is modeled as a first capacitor C₁ electrically coupled between the node 208 to be touched and the ground, and another capacitance C₂ is modeled as a second capacitor C₂ electrically coupled between the node 208 to be touched and the ground. The resistors R, the inductors L and the capacitors C₁/C₂ therefore form a filter that can change the characteristic of an input signal (provided by the driving circuit 22) inputted to the input node 204. The locations of the touching points can then be determined by analyzing response characteristic (e.g., filter coefficients) at the output node 206 by the measuring circuit 24.

FIG. 4B shows another electrical equivalent circuit of one conductive line 202 after three nodes 208 are touched, for example, by fingers. Capacitance C₁, capacitance C₂ and capacitance C₃ are respectively introduced due to the interaction between the fingers and the electromagnetic field along the conductive line 202 that is activated. The capacitances C₁, C₂ and C₃ are modeled as a first capacitor C₁, a second capacitor C₂ and a third capacitor C₃ respectively. The resistors R, the inductors L and the capacitors C₁/C₂/C₃ therefore form a filter that can change the characteristic of an input signal fed to the input node 204. The locations of the touching points can then be determined by analyzing response characteristic at the output node 206. It is particularly noted that the resultant filter with dual touch as shown in FIG. 4A is distinct from the resultant filter with triple touch as shown in FIG. 4B, for example, with distinct filter coefficients.

Specifically speaking, a single touch will make the transfer function of the conductive line 202 a second-order function. A dual touch will make the transfer function of the conductive line 202 a fourth-order function. A triple touch will make the conductive line 202 a six-order function. As these transfer functions alter the input signal in different ways, the number of touching points and their corresponding locations can be determined according to the given characteristic of the input signal and the measured characteristics of the output signal.

With respect to the equivalent circuit shown in FIG. 4B, for example, there are three touching points where capacitances are introduced respectively. A sub-transfer function (H₁, H₂ or H₃) is thus generated associated with each introduced capacitor (C₁, C₂ or C₃). Therefore, the overall transfer function H of the entire conductive line 202 may be obtained by multiplying the three sub-transfer functions H₁, H₂ and H₃. To elaborate, the sub-transfer functions H₁, H₂ and H₃ and the overall transfer function H may be derived as follows:

$${H}_{1} ( s ) = \frac{\frac{1}{{sC}_{1}}}{R + sL + \frac{1}{{sC}_{1}}} = \frac{1}{{s}^{2} {LC}_{1} + {sRC}_{1} + 1}$$

$${H}_{2} ( s ) = \frac{\frac{1}{{sC}_{2}}}{3 R + 3 sL + \frac{1}{{sC}_{2}}} = \frac{1}{3 {s}^{2} {LC}_{2} + 3 {sRC}_{2} + 1}$$

$${H}_{3} ( s ) = \frac{\frac{1}{{sC}_{3}}}{R + sL + \frac{1}{{sC}_{3}}} = \frac{1}{{s}^{2} {LC}_{3} + {sRC}_{3} + 1}$$

$$H ( s ) = {H}_{1} ( s ) \cdot {H}_{2} ( s ) \cdot {H}_{3} ( s ) = \frac{1}{( {s}^{2} {LC}_{1} + {sRC}_{1} + 1 ) ( 3 {s}^{2} {LC}_{2} + 3 {sRC}_{2} + 1 ) ( {s}^{2} {LC}_{3} + {sRC}_{3} + 1 )} = \frac{1}{( \begin{matrix}3 {s}^{6} {L}^{3} {C}_{1} {C}_{2} {C}_{3} + 9 {s}^{5} {RL}^{2} {C}_{1} {C}_{2} {C}_{3} + 9 {s}^{4} {RL}^{2} {C}_{1} {C}_{2} {C}_{3} + \\ 3 {s}^{4} {L}^{2} {C}_{2} {C}_{3} + 3 {s}^{4} {L}^{2} {C}_{1} {C}_{2} + {s}^{4} {L}^{2} {C}_{1} {C}_{3} + 2 {s}^{2} {RLC}_{1} {C}_{3} + \\ 6 {s}^{3} {RLC}_{2} {C}_{3} + 6 {s}^{3} {RLC}_{1} {C}_{2} + 3 {s}^{3} {R}^{3} {C}_{1} {C}_{2} {C}_{3} + 3 {s}^{2} {R}^{2} {C}_{1} {C}_{2} + \\ 3 {s}^{2} {LC}_{2} + 3 {s}^{2} {R}^{2} {C}_{2} {C}_{3} + {s}^{2} {R}^{2} {C}_{1} {C}_{3} + {s}^{2} {LC}_{3} + \\ {s}^{2} {LC}_{1} + {sRC}_{3} + {sRC}_{1} + 3 {sRC}_{2} + 1\end{matrix} )}$$

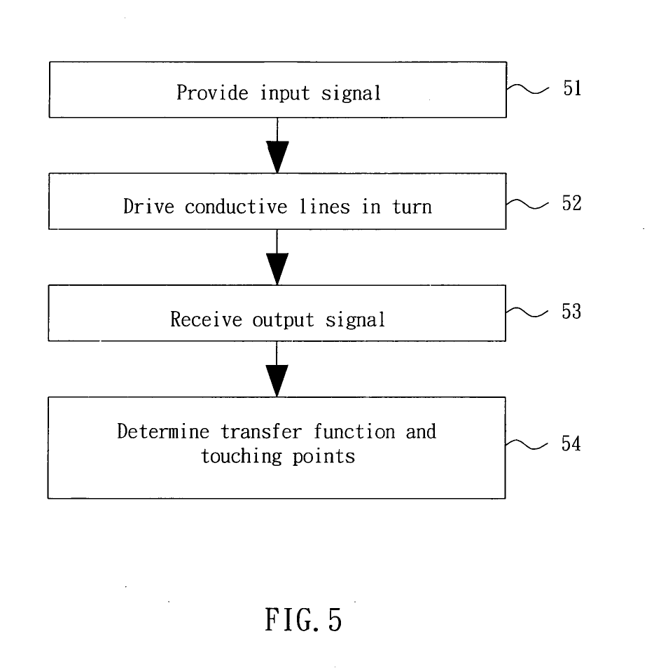

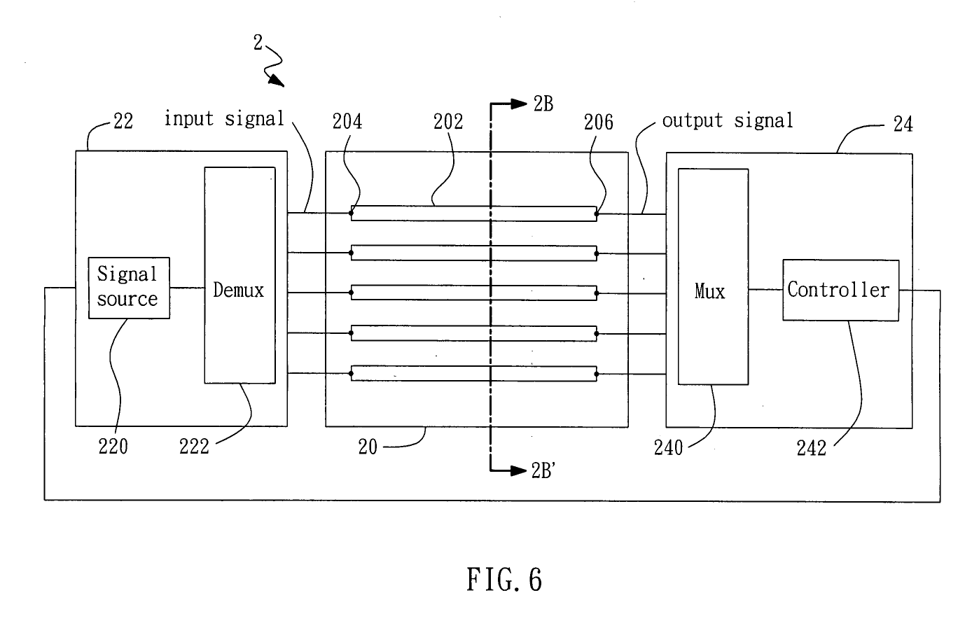

FIG. 5 shows a flow diagram that illustrates a method of operating a single-axis capacitive multi-touch system 2 (FIG. 2A) according to one embodiment of the present invention. Specifically, in step 51, an input signal is provided by the driving circuit 22 and is then used to drive the multi-touch panel 20 at the input nodes 204. The input signal is preferably an alternating-current (AC) signal. FIG. 6 shows an exemplary embodiment of the multi-touch system 2. Specifically, the driving circuit 22 includes a signal source 220 configured to generate the required input signal. The generated input signal is then demultiplexed by a demultiplexer (Demux) 222, which transfers the input signal to one of the conductive lines 202 at a time. Subsequently, the transferred (or demultiplexed) input signal is then used to drive the conductive lines 202 in turn (step 52). As described above, each conductive line 202 has certain resistance and certain inductance. The inductive reactance of the conductive line 202 will change based on the frequency of the input signal applied to the conductive line 202. The shape of the conductive line 202 may affect the resistance and the inductive reactance. For example, a curved conductive line 202 has higher resistance and inductive reactance than a straight conductive line 202. Specifically speaking, the conductive line generates electromagnetic field when an alternating current flows through it. The electromagnetic field generation produces inductance where the inductive reactance of the conductive line changes with the changing frequency. If an object such a finger touches the conductive line 202 and introduces a capacitance as a result of the touch, then the combination of the inductance, the resistance and the capacitance will form a filter that will accordingly change the characteristics of the input signal.

Afterwards, in step 53, the output signal is received by the measuring circuit 24. In the exemplary embodiment as shown in FIG. 6, the measuring circuit 24 includes a multiplexer (Mux) 240 configured to receive and pass the output signal from one of the conductive lines 202 at a time. The measuring circuit 24 also includes a controller 242 configured to measure transient response in synchronization with the driving circuit 22. Based on the signal characteristics at both ends, i.e., the input node 204 and the output node 206, of the conductive line 202, the controller 242 can then determine the characteristics (e.g., filter coefficients) of the transfer function of the conductive line. 202 (step 54). This in turn leads to the determination of the touching points on the conductive line 202. By knowing the signal characteristics at the both ends of the conductive line, the location of the capacitance can be determined. Thus, the multiple touches on the same conductive line also can be detected.

Specifically speaking, the coefficients of the transfer function of the conductive line 202 in the embodiment may be obtained; for example, according to the method disclosed in U.S. Pat. No. 7,251,791, entitled “Methods to Generate State Space Models by Closed Forms and Transfer Functions by Recursive Algorithms for RLC Interconnect and Transmission Line and Their Model Reduction and Simulation,” by Wang, the disclosure of which is hereby incorporated by reference. According to the disclosed method and model, the transient responses at all nodes 208 on the conductive line 202 can be efficiently and accurately obtained. Accordingly, the number of the touching points and their corresponding locations can be determined according to the obtained coefficients of the transfer function.

Although specific embodiments have been illustrated and described, it will be appreciated by those skilled in the art that various modifications may be made without departing from the scope of the present invention, which is intended to be limited solely by the appended claims.

What is claimed is:

1. A single-axis capacitive multi-touch panel, comprising:
a substrate; and
a plurality of conductive lines formed on one side of the substrate, wherein the conductive lines are arranged in a single axis and each said conductive line is operatively coupled to an alternating-current signal, and an output signal according to the alternating-current signal is then measured to determine touch location.

2. The panel of claim 1, wherein the alternating-current signal is introduced to one end of the conductive line and the output signal is measured at the other end of the same conductive line.

3. The panel of claim 1, wherein the output signal is changed based on a frequency of the alternating-current signal.

4. The panel of claim 1, wherein each said conductive line has inherent resistance, the conductive line generates electromagnetic field when said alternating-current signal passes through the conductive line, an inductive reactance produced by the electromagnetic field changes with the respective frequency of the alternating-current signal, and a capacitance is introduced at any touch point of the conductive line, thereby a combination of the inherent resistance, the inductive reactance and the capacitance forming a filter, based on which multiple touches on the conductive line are capably determined.

5. The panel of claim 1, wherein the conductive lines are of a shape of elongated line.

6. The panel of claim 1, wherein the conductive lines are spatially separated from each other without crossing, and are parallel to each other.

7. The panel of claim 1, wherein the conductive lines are made of Indium tin oxide (ITO) or Antimony tin oxide (ATO).

8. The panel of claim 1, wherein the substrate is a transparent substrate.

9. The panel of claim 1, wherein the substrate is made of glass or plastic.

10. The panel of claim 1, further comprising:
a display disposed at the back of the substrate; and
a cover disposed in front of the substrate;
wherein the cover, the substrate and the display are bonded together to result in a touchscreen display.

11. A single-axis capacitive multi-touch system, comprising:
a multi-touch panel having a substrate and a plurality of conductive lines formed on one side of the substrate, wherein the conductive lines are arranged in a single axis;
a driving circuit, for producing an alternating-current signal, operatively coupled to the conductive lines of the multi-touch panel; and
a measuring circuit, for receiving an output signal according to the alternating-current signal to determine touch location, operatively coupled to the conductive lines of the multi-touch panel.

12. The system of claim 11, wherein the output signal is changed based on a frequency of the alternating-current signal.

13. The system of claim 11, wherein each said conductive line has inherent resistance, the conductive line generates electromagnetic field when said alternating-current signal passes through the conductive line, an inductive reactance produced by the electromagnetic field changes with the respective frequency of the alternating-current signal, and a capacitance is introduced at any touch point of the conductive line, thereby a combination of the inherent resistance, the inductive reactance and the capacitance forming a filter, based on which multiple touches on the conductive line are capably determined.

14. The system of claim 1 1, wherein the driving circuit operatively couples to a plurality of input nodes of the multi-touch panel, and the measuring circuit operatively couples to a plurality of output nodes of the multi-touch panel.

15. The system of claim 11, further comprising:
a display disposed at the back of the multi-touch panel; and
a cover disposed in front of the multi-touch panel;
wherein the cover, the multi-touch panel and the display are bonded together to result in a touchscreen display.

16. The system of claim 11, wherein the substrate is a transparent substrate.

17. The system of claim 11, wherein the substrate is made of glass or plastic.

18. The system of claim 11, wherein the conductive lines are of a shape of elongated line.

19. The system of claim 11, wherein the conductive lines are made of Indium tin oxide (ITO) or Antimony tin oxide (ATO).

20. The system of claim 11, wherein the conductive lines are spatially separated from each other without crossing, and are parallel to each other.

21. The system of claim 11, wherein the driving circuit and the measuring circuit are disposed on a peripheral edge of the substrate.

22. The system of claim 11, further comprising at least one flexible printed circuit board used to connect the driving circuit and the measuring circuit to the multi-touch panel.

23. The system of claim 11, wherein the driving circuit is configured to provide the alternating-current signal to drive the conductive lines in turn, and the measuring circuit works in synchronization with the driving circuit and is configured to receive an output signal from one of the conductive lines at a time, thereby characteristics of a transfer function of the conductive line is determined based on the alternating-current signal and the output signal, and touching points on the conductive line are accordingly determined.

24. The system of claim 23, wherein the driving circuit comprises:
a signal source configured to generate the alternating-current signal; and
a demultiplexer configured to transfer the generated alternating-current signal to one of the conductive lines at a time.

25. The system of claim 23, wherein the measuring circuit comprises:
a multiplexer configured to receive the output signal from one of the conductive lines at a time; and
a controller configured to determine the characteristics of the transfer function of the conductive line.

26. A single-axis capacitive multi-touch method, comprising:
providing an alternating-current signal;
driving a plurality of conductive lines in turn by the alternating-current signal to generate an electromagnetic field;
receiving an output signal from the conductive lines; and
determining characteristics of a transfer function of the conductive line based on the alternating-current signal and the output signal, thereby determining touching points on the conductive line.

27. The method of claim 26, wherein the step of providing the alternating-current signal comprises:
generating the alternating-current signal; and
demultiplexing the alternating-current signal to transfer the generated alternating-current signal to one of the conductive lines at a time.

28. The method of claim 26, wherein an inductive reactance of the conductive line produced by the electromagnetic field changes with the respective frequency of the alternating-current signal.

29. The method of claim 26, wherein the step of receiving the output signal comprises:
multiplexing to obtain the output signal from one of the conductive lines at a time, wherein the output signal is received in synchronization with driving the conductive lines with the alternating-current signal.

30. The method of claim 26, further comprising:
touching the single-axis capacitive multi-touch panel at one or more touching points, thereby correspondingly introducing at least one capacitance;
wherein inherent resistance and inductance of the conductive line and the introduced capacitance together form a filter that accordingly changes characteristics of the alternating-current signal.

31. The method of claim 26, wherein the step of determining the characteristics of the transfer function comprises:
obtaining coefficients of the transfer function; and
determining the number of the touching points and their corresponding locations on the conductive line according to the obtained coefficients of the transfer function.
